(19) United States
(12) Patent Application Publication
(10) Pub. No.: US 2016/0103538 A1
(43) Pub. Date: Apr. 14, 2016

(54) ELECTRONIC DEVICE AND ACCESS CONTROL METHOD

(71) Applicant: Chiun Mai Communication Systems, Inc., New Taipei (TW)

(72) Inventor: CHIEN-HUNG CHENG, New Taipei (TW)

(21) Appl. No.: 14/796,128

(22) Filed: Jul. 10, 2015

(30) Foreign Application Priority Data
Oct. 14, 2014 (CN) 201410539595.8

(51) Int. Cl. G06F 3/041; G06F 21/82; G06F 3/0488

(52) U.S. Cl. CPC G06F 3/0412; G06F 3/0488; G06F 21/82

(57) ABSTRACT

A method for unlocking an electronic device includes identifying a slide path according to touch signals received from a preset touch area of a touch screen of the electronic device when the electronic device is locked. Once the identified slide path is determined to include a preset slide path and passes preset discrete points, and a number of passing times of each of the preset discrete points is equal to preset number of times, the electronic device is unlocked.

### CROSS-REFERENCE TO RELATED APPLICATIONS

This application claims priority to Chinese Patent Application No. 201410539595.8 filed on Oct. 14, 2014, the contents of which are incorporated by reference herein.

### FIELD

The subject matter herein generally relates to electronic device security technology, and particularly to an electronic device and a method for controlling access to the electronic device.

### BACKGROUND

An electronic device may be unlocked using a slide operation, for example, as illustrated in FIG. 1, the electronic device is unlocked when a slide path 10 matches a preset slide path. However, this kind of unlocking method is too simple, and easy to be known by an illegal user.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates an example of unlocking an electronic device using a slide operation.

FIG. 2 is a block diagram of one embodiment of an electronic device including an unlocking system.

FIG. 3 is a block diagram of one embodiment of functional modules of the unlocking system.

FIG. 4 illustrates a flowchart of one embodiment of a method for unlocking the electronic device of FIG. 1.

FIG. 5 illustrates an example of a password of unlocking the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

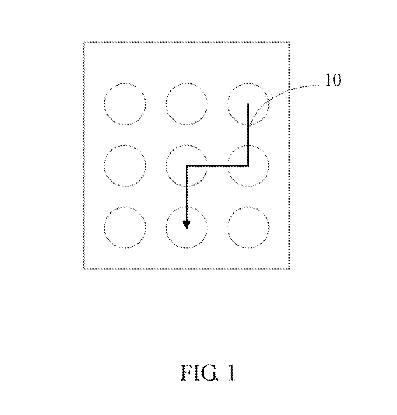

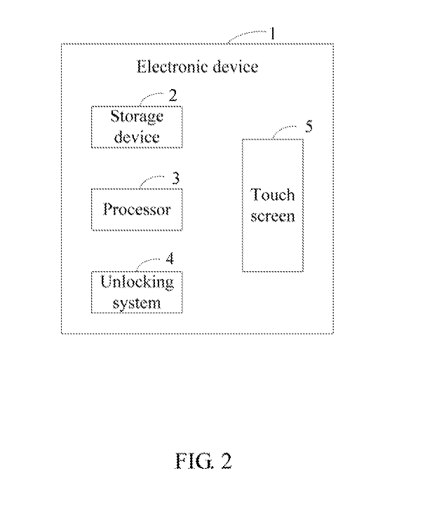

FIG. 2 is a block diagram of one embodiment of an electronic device. The electronic device 1 can be a smart phone, a personal digital assistant (PDA), a tablet computer, or any other suitable electronic device. In at least one embodiment, the electronic device 1 includes a storage device 2, at least one processor 3, an unlocking system 4, and a touch screen 5. FIG. 1 illustrates only one example of the electronic device 1 that can include more or fewer components than illustrated, or have a different configuration of the various components in other embodiments.

In at least one embodiment, the storage device 2 can be an internal storage device, such as a flash memory, a random access memory (RAM) for temporary storage of information, and/or a read-only memory (ROM) for permanent storage of information. The storage device 2 can also be an external storage device, such as an external hard disk, a storage card, or a data storage medium.

The at least one processor 3 can be a central processing unit (CPU), a microprocessor, or other data processor chip that performs functions of the electronic device 1.

The touch screen 5 can be a capacitive touch screen, a resistive touch screen, a piezoelectric touch screen, or an infrared touch screen.

The unlocking system 4 can unlock the electronic device 1 with the aid of the storage device 2, the at least one processor 32, and the touch screen 5. Details will be given in the following paragraphs.

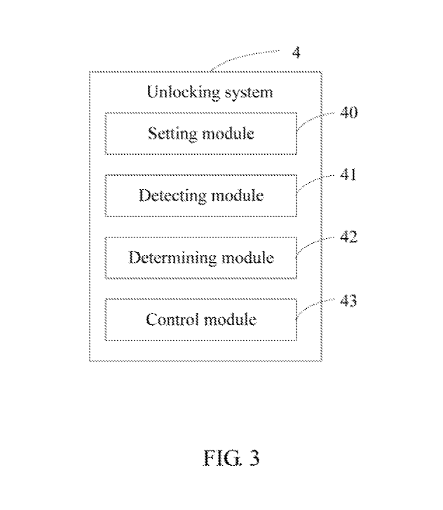

FIG. 3 is a block diagram of one embodiment of function modules of the unlocking system 4. In at least one embodiment, the unlocking system 4 can include a storing module 40, a detecting module 41, a determining module 42, and a control module 43. The function modules 40-43 can include computerized codes in the form of one or more programs, which are stored in the storage device 2, and are executed by the at least one processor 3 of the electronic device 1 to provide functions of unlocking the electronic device 1. Details will be given in the following paragraphs.

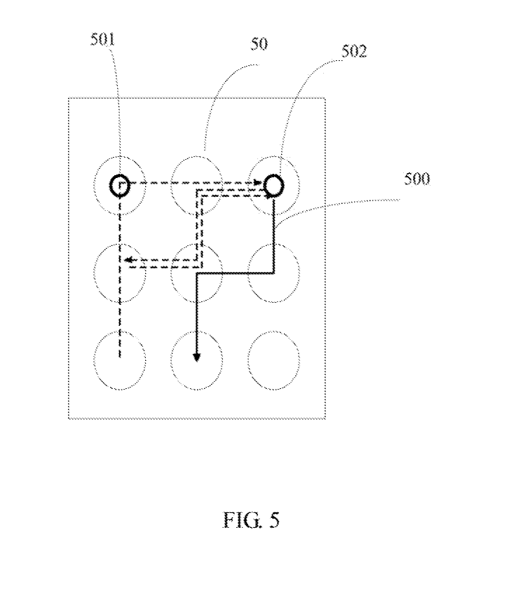

FIG. 5 illustrates the setting module 40 can preset a slide path 500 on a preset touch area 50 of the touch screen 5, and preset one or more discrete points, such as 501, 502, on the preset touch area 50. The setting module 40 can further preset a number of passing times of each of the preset discrete points. The setting module 40 stores the preset slide path 500, the preset discrete points, and the preset number of passing times of each of the preset discrete points in the storage device 2.

The preset touch area 50 can be a matrix in a form of a multi-grid pattern, such as the nine-grid pattern shown in FIG. 5 or a matrix in a form of a sixteen-grid pattern.

The preset slide path 500 can be a closed curve, an open curve, or a cross curve. In this exemplary embodiment in FIG. 5, the preset slide path 500 is an open curve.

In this exemplary embodiment, the one or more preset discrete points can include a first discrete point 501 and a second discrete point 502. In one example, the preset number of passing times of the first discrete point 501 can be one time, and the preset number of times of passing the second discrete point 502 can be two times.

When the electronic device 1 is locked, the detecting module 41 can identify a slide path according to touch signals received from the preset touch area 50.

In at least one embodiment, the determining module 42 can analyze whether the identified slide path includes the preset slide path 500 and passes the preset discrete points. The determining module 42 further can analyze whether a number of passing times of each of the preset discrete points is equal to the preset number of times.

When the identified slide path includes the preset slide path 500 and passes the preset discrete points, and the number of times of passing each of the identified discrete points is equal to the preset number of times, the control module 43 can unlock the electronic device 1.

When the preset slide path 500 is not included in the identified slide path, or the identified slide path does not pass at least one of the preset discrete points, or the identified number of passing times of at least one of the preset discrete points is not equal to the corresponding preset number of times, the control module 43 can keep the electronic device 1 in a locked state.

In another embodiment, the determining module 42 can further analyze an order of passing each of the preset discrete points in the identified slide path, and determine whether the analyzed order is equal to a preset order.

When the analyzed order is equal to the preset order, the control module 43 can unlock the electronic device 1. When the analyzed order is not equal to the preset order, the control module 43 can keep the electronic device 1 in a locked state.

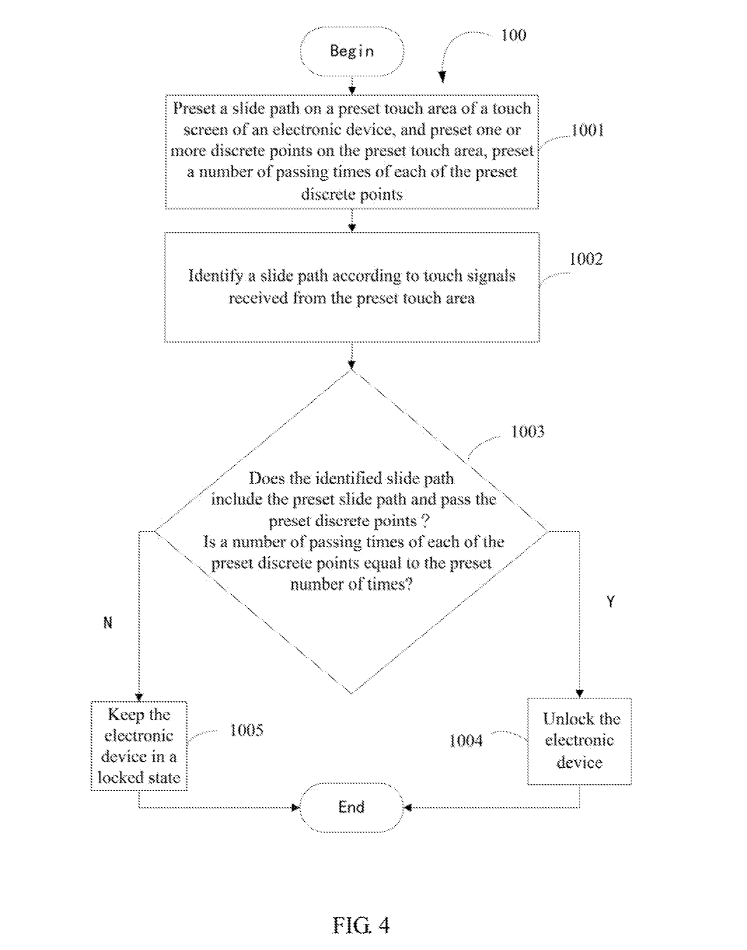

FIG. 4 illustrates a flowchart is presented in accordance with an example embodiment. The example method 100 is provided by way of example, as there are a variety of ways to carry out the method. The method 100 described below can be carried out using the configurations illustrated in FIG. 2, for example, and various elements of these figures are referenced in explaining example method 100. Each block shown in FIG. 4 represents one or more processes, methods or subroutines, carried out in the exemplary method 100. Additionally, the illustrated order of blocks is by example only and the order of the blocks can be changed according to the present disclosure. The exemplary method 100 can begin at block 1001. Depending on the embodiment, additional steps can be added, others removed, and the ordering of the steps can be changed.

At block 1001, FIG. 5 illustrates a setting module can preset a slide path on a preset touch area of the touch screen, and preset one or more discrete points on the preset touch area. The setting module can further preset a number of passing times of each of the preset discrete points. The setting module stores the preset slide path, the preset discrete points, and the preset number of passing times of each of the preset discrete points in a storage device of an electronic device.

The preset touch area can be a matrix in a form of a multi-grid pattern, such as the nine-grid pattern shown in FIG. 5 or a matrix in a form of a sixteen-grid pattern.

The preset slide path can be a closed curve, an open curve, or a cross curve. In this exemplary embodiment in FIG. 5, the preset slide path is an open curve.

In this exemplary embodiment, the one or more preset discrete points can include a first discrete point and a second discrete point. In one example, the preset number of times of passing the first discrete point can be one time, and the preset number of times of passing the second discrete point can be two times.

At block 1002, when the electronic device is locked, a detecting module can identify a slide path according to touch signals received from the preset touch area.

At block 1003, in one embodiment, the determining module can analyze whether the identified slide path includes the preset slide path and passes the preset discrete points. The determining module further can analyze whether a number of passing times of each of the preset discrete points is equal to the preset number of times.

When the identified slide path includes the preset slide path and passes the preset discrete points, and the number of passing times of each of the identified discrete points is equal to the preset number of times, the process goes to block 1004.

When the preset slide path is not included in the identified slide path, or if the identified slide path does not pass at least one of the preset discrete points, or the identified number of passing times of at least one of the preset discrete points is not equal to the corresponding preset number of times, the process goes to block 1005.

In another embodiment, the determining module can further analyze an order of passing each of the preset discrete points in the identified slide path, and determine whether the analyzed order is equal to a preset order.

When the analyzed order is equal to the preset order, the process goes to block 1004.

When the analyzed order is not equal to the preset order, the process goes to block 1005.

At block 1004, a control module can unlock the electronic device.

At block 1005, the control module can keep the electronic device in a locked state.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method of unlocking an electronic device using at least one processor of the electronic device, the electronic device comprising a touch screen, the method comprising:
identifying a slide path according to touch signals received from a preset touch area of the touch screen when the electronic device is locked;
analyzing whether the identified slide path includes a preset slide path and passes preset discrete points;
analyzing whether a number of passing times of each of the preset discrete points is equal to a preset number of times;
unlocking the electronic device upon condition that the identified slide path includes the preset slide path and passes the preset discrete points, and the number of passing times of each of the preset discrete points is equal to the preset number of times.

2. The computer-implemented method according to claim 1, wherein the preset slide path is a closed curve, an open curve, or a cross curve.

3. The computer-implemented method according to claim 1, wherein the preset touch area is a matrix in a form of a multi-grid pattern.

4. The computer-implemented method according to claim 1, wherein the method further comprises:
analyzing an order of passing each of the preset discrete points in the identified slide path; and
determining whether the analyzed order is equal to a preset order.

5. The computer-implemented method according to claim 4, wherein the electronic device is unlocked when the analyzed order is equal to the preset order.

6. An electronic device comprising:
a touch screen;
at least one processor;
a storage device being configured to store one or more programs that, when executed by the at least one processor, cause the at least one processor to:
identify a slide path according to touch signals received from a preset touch area of the touch screen when the electronic device is locked;
analyze whether the identified slide path includes a preset slide path and passes preset discrete points;
analyze whether a number of passing times of each of the preset discrete points is equal to a preset number of times;
unlock the electronic device when the identified slide path includes the preset slide path and passes the preset discrete points, and the number of passing times of each of the preset discrete points is equal to the preset number of times.

7. The electronic device according to claim 6, wherein the preset slide path is a closed curve, an open curve, or a cross curve.

8. The electronic device according to claim 6, wherein the preset touch area is a matrix in a form of a multi-grid pattern.

9. The electronic device according to claim 6, wherein the at least one processor further:
analyzing an order of passing each of the preset discrete points in the identified slide path; and
determining whether the analyzed order is equal to a preset order.

10. The electronic device according to claim 9, wherein the electronic device is unlocked when the analyzed order is equal to the preset order.

11. A non-transitory storage medium having stored thereon instructions that, when executed by a processor of an electronic device, causes the processor to perform a method for unlocking the electronic device, the electronic device comprising a touch screen, wherein the method comprises: identifying a slide path according to touch signals received from a preset touch area of the touch screen when the electronic device is locked;
analyzing whether the identified slide path includes a preset slide path and passes preset discrete points;
analyzing whether a number of passing times of each of the preset discrete points is equal to a preset number of times; and
unlocking the electronic device when the identified slide path includes the preset slide path and passes the preset discrete points, and the number of passing times of each of the preset discrete points is equal to the preset number of times.

12. The non-transitory storage medium according to claim 11, wherein the preset slide path is a closed curve, an open curve, or a cross curve.

13. The non-transitory storage medium according to claim 11, wherein the preset touch area is a matrix in a form of a multi-grid pattern.

14. The non-transitory storage medium according to claim 11, wherein the method further comprising:
analyzing an order of passing each of the preset discrete points in the identified slide path; and
determining whether the analyzed order is equal to a preset order.

15. The non-transitory storage medium according to claim 14, wherein the electronic device is unlocked when the analyzed order is equal to the preset order.
